(19) United States
(12) Patent Application Publication
(10) Pub. No.: US 2009/0055782 A1
(43) Pub. Date: Feb. 26, 2009

(54) Secure Yield-aware Design Flow with Annotated Design Libraries

(76) Inventors: Chung-Min Fu, Chungli (TW); Yi-Kan Cheng, Taipei (TW)

Correspondence Address: SLATER & MATSIL, L.L.P., 17950 PRESTON ROAD, SUITE 1000, DALLAS, TX, 75252, US

(21) Appl. No.: 11/841,509

(22) Filed: Aug. 20, 2007

(51) Int. Cl. G06F 17/50

(52) U.S. Cl. 716/4

(57) ABSTRACT

A method for designing and manufacturing integrated circuits is provided. The method includes providing a modeling parameter set for manufacturing an integrated circuit; dividing the modeling parameter set into time-dependent data and time-independent data; saving substantially all time-independent data into a design library; and saving substantially all time-dependent data into a design-for-manufacturing (DFM) data kit, wherein the DFM data kit is external to the design library.

### TECHNICAL FIELD

This invention relates generally to integrated circuit manufacturing processes, and more particularly to design-for-manufacturing (DFM) systems, and even more particularly to yield assessment for integrated circuit design and manufacture.

### BACKGROUND

Design-for-manufacturing (DFM) is a development practice emphasizing manufacturing issues throughout product design processes. Successful DFM results in lower production costs without sacrificing product quality starting from the early design stages.

Nowadays, DFM-aware designs are increasingly performed. In the design stages, the intermediate designs are typically off-lined to perform DFM checks to ensure that the designs are DFM-compliant, and to modify the designs if problems are found. During full-chip implementations, extra steps of sign-off analysis also need to be performed and repeated in case of re-design interactions. These steps waste time and resources by performing duplicate physical analysis of integrated circuits, for example, re-characterize intellectual property (IP)/cells.

It is cost-efficient if designers can assess the manufacturing concerns, for example, to determine the yield of a design, and to determine whether to adopt the design or not during the early development stages. However, the yield-assessing tools incorporated into the DFM platforms, if they exist at all, can only parse yields at one time point, and the design library cannot be periodically updated for varying yields at different time points, not to mention the yield values are not intended to be disclosed in reality.

A further problem is that the design of a chip typically lasts several quarters or more, with individual parts of the chip designed during different times. Therefore, it is difficult to assess the design, for example, to predict the yield. This is because manufacturing processes are continuously evolving, and thus certain factors, for example, yields, lithography recipes, and stresses, change with time. Therefore, a design may be started at an immature stage of 90 nm technology, but when the design is finished, it becomes part of the mature stage of the technology due to the constant improvements in the manufacturing processes. The manufacturing technology may even change from 90 nm to 65 nm. During this period of time, the yield also changes with time, hopefully an improvement. The assessments made during different time frames are relative to a same time point, providing no means of comparison, and thus are of little value. Since the existing DFM platforms do not take the time-dependent nature of the manufacturing processes into account, even if a designer is willing to tradeoff between several possible designs, for example, a high-performance design and a high-yield design, the designer still has no means for accurately assessing the potential outcome of the designs at early design stages. Accordingly, new design methodology and new DFM platforms for solving the above-discussed problems are needed.

### SUMMARY OF THE INVENTION

In accordance with one aspect of the present invention, a design system includes a design library comprising substantially only time-independent data; a design-for-manufacturing (DFM) data kit comprising substantially only time-dependent data; and a tool for reading the time-independent data and the time-dependent data.

In accordance with another aspect of the present invention, a design system includes a design library comprising substantially only time-independent data for designing and manufacturing an integrated circuit; a DFM data kit comprising substantially only time-dependent data for designing and manufacturing the integrated circuit; an encryption tool for encrypting the time-dependent data; a decryption tool for decrypting the time-dependent data; and an electronic design automation (EDA) tool for reading the time-independent data, and reading the time-dependent data using the decryption tool.

In accordance with yet another aspect of the present invention, a design system includes a design library comprising substantially only time-independent data for designing and manufacturing an integrated circuit, wherein the time-independent data comprise a critical area of the integrated circuit; a DFM data kit comprising substantially only time-dependent data for designing and manufacturing the integrated circuit, wherein the time-dependent data comprise a defect density; an encryption tool for encrypting the time-dependent data in the DFM data kit; a decryption tool for decrypting the time-dependent data; and an electronic design automation (EDA) tool for reading the critical area, reading the defect density using the decryption tool, and for calculating a yield using the critical area and the defect density.

In accordance with yet another aspect of the present invention, a method for designing and manufacturing integrated circuits includes providing a modeling parameter set for manufacturing an integrated circuit; dividing the modeling parameter set into time-dependent data and time-independent data; saving substantially all time-independent data into a design library; and saving substantially all time-dependent data into a DFM data kit, wherein the DFM data kit is external to the design library.

In accordance with yet another aspect of the present invention, a method for designing and manufacturing integrated circuits includes providing a modeling parameter set for manufacturing an integrated circuit; dividing the modeling parameter set into time-dependent data and time-independent data; saving substantially all time-independent data into a design library; at the time the time-independent data is saved, calculating a critical area of the integrated circuit and saving the critical area; and saving substantially all time-dependent data into a DFM data kit external to the design library, wherein the time-dependent data comprise a defect density.

By dividing the modeling parameter set into time-independent and time-dependent portions, design effort is saved. Therefore, proprietary information is better protected.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a block diagram of an embodiment of the present invention;

FIG. 2 illustrates an exemplary design library file; and

FIG. 3 illustrates an exemplary design-for-manufacturing data kit file.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Interactions and communications between designers and manufacturers may be enhanced for more accurate, faster, and more efficient designs, by using design-for-manufacturing, or DFM. In one example, various manufacturing data are formulated, quantified, and integrated to enable collaboration between manufacturers and designers, reducing design time and design cost, and increasing manufacturing yield and production performance. DFM can be realized at various design stages with a collaboration of design tool vendors. The manufacturers may be semiconductor foundries. The designers may be integrated circuit (IC) design houses. The design tool vendors may be electronic design automation (EDA) tool vendors. In some examples, a single company may include two, or even all three.

The results (outcome) of manufacturing an integrated circuit are related to a set of modeling parameters, which includes many individual modeling parameters (data). The modeling parameter set can generally be categorized as two portions, time-independent data and time-dependent data. Time-independent data are those that stay relatively the same over the course of time, for example, physical data (such as the layout of the integrated circuit), electrical data (such as the powers to be applied, and the timing of the devices in the integrated circuits), and the like. These data are not affected when the integrated circuit is manufactured, and hence are referred to as “time-independent.” Some other data, such as the manufacturing yields (referred to as yield hereinafter) and lithography recipes, are time-dependent. For example, at the inception time of a new technology, the manufacturing yield may be low, perhaps changing with time when the manufacturing processes are modified. It may be expected that at the mature time of the new technology, the yield is improved. Similarly, the lithography recipe is also modified and improved with time. In general, the variation of the manufacturing process is dynamic, and thus is time-dependent.

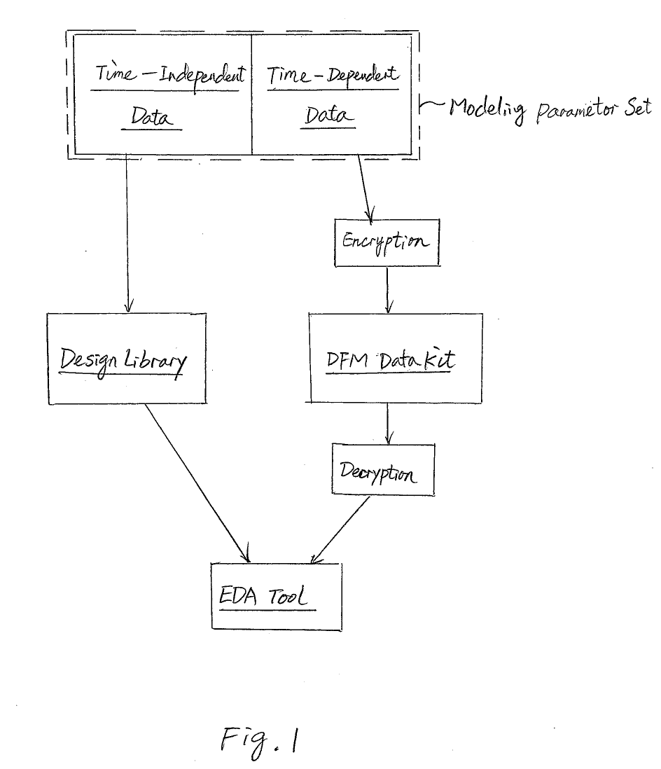

FIG. 1 illustrates a block diagram of an embodiment of the present invention, which shows that the modeling parameter set is divided into the time-independent data and time-dependent data. The time-independent data may be saved in a design library, which may be in the form of commonly accepted “.lib” format, or any other customized formats. The time-dependent data, on the other hand, is saved in a DFM data kit (DDK) external to the design library. Throughout the description, the DDK is alternatively referred to as a DDK file, although it may be in other forms such as database, scripts, and the like. In the preferred embodiment, the DDK is encrypted by an encryption tool. The EDA tool has the permission to access, and can parse, all of the necessary modeling parameters, including those saved in the design library and in the DDK file. Preferably, a decryption tool is provided to the EDA tool vendor, who may integrate the decryption tool into the EDA tool in order to decrypt the DDK file.

In the preferred embodiment, all time-independent data are saved in the design library, and all time-dependent data are saved in the DDK file. However, if necessary, a small amount of time-independent data may be saved in the DDK file, while a small amount of time-dependent data may be saved in the design library.

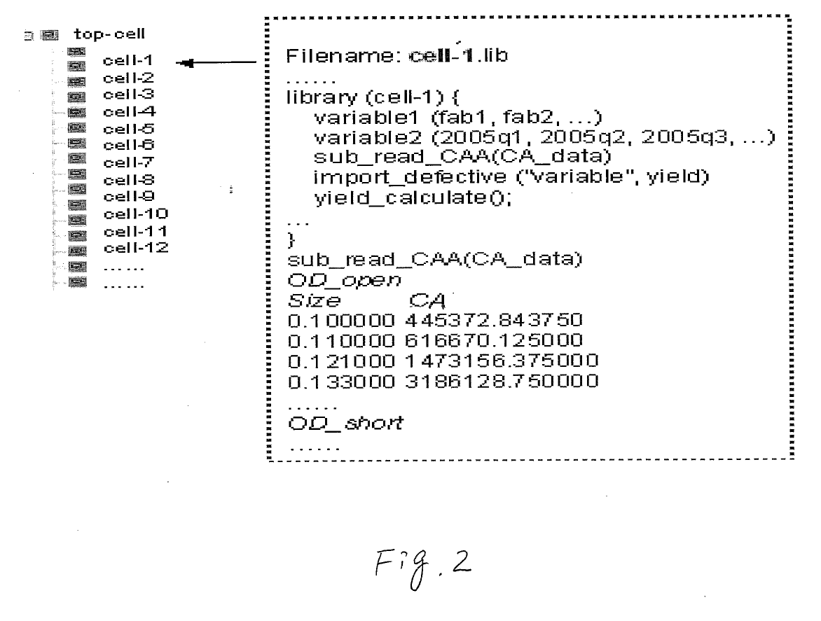

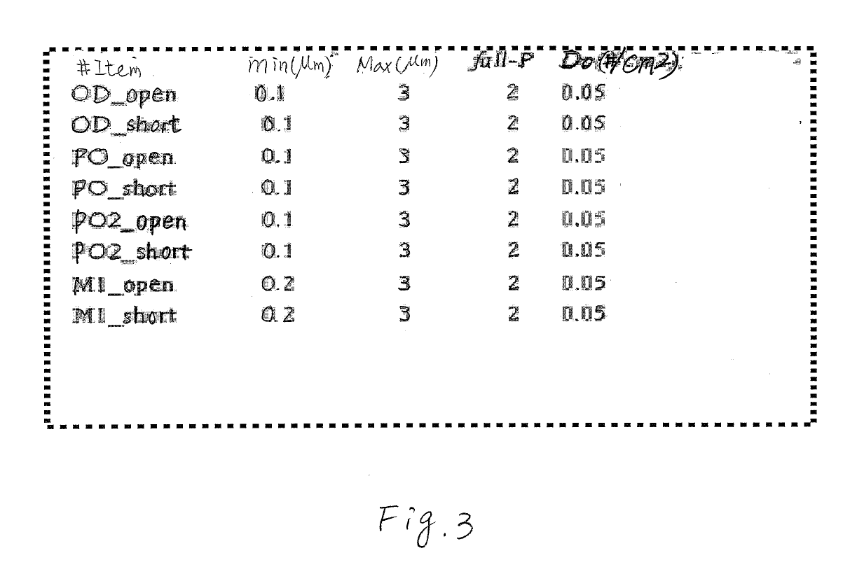

FIGS. 2 and 3 illustrate an exemplary design library file “cell-1.lib” for an integrated circuit design, and an exemplary DDK file, respectively. Please note that FIGS. 2 and 3 are only examples used for explaining the concept the present invention. One skilled in the art may use any suitable format for achieving the concept taught through the embodiments of the present invention. The discussed example shows how the yield of the integrated circuit can be assessed by using the time-independent data and the time-dependent data.

A yield of an integrated circuit may be expressed using Poisson yield model as:

Yield=exp (−CA*D₀) [Eq. 1]

wherein CA is the critical area of the integrated circuit to be manufactured, and D₀ is the defect density per unit critical area. Critical area CA may be found in the design library file shown in FIG. 2. D₀ is shown in FIG. 3, the right column. In FIG. 2, the design library file has the function of reading the critical area CA through the sub-routine of sub_read_CAA (CA_data). The sub-routine import defective (“variable,” yield) in FIG. 3 has the function of importing the defect density D₀. The importing of defect density D₀ performed using a link through, for example, a keyword “OD_open,” which is linked to a row starting with “OD_open” in the DDK file (FIG. 3). Therefore, when the sub-routine yield calculate (in the cell-1.lib file is executed, the program control may be transferred to an EDA tool, which has access to both critical area CA and defect density D₀ (refer to FIG. 1). The yield calculation may be as simple as specified in Equation 1, or in a more complicated form involving parameters other than critical area CA and defect density D₀.

Preferably, critical area CA is characterized at the time the design library file cell-1.lib is created in an intellectual property (IP) platform or a design database. The necessary information of calculating critical area CA is also retrieved from the design library file cell-1.lib. The calculated critical area CA may be saved back to the design library file cell-1. lib, or to a separate file. The design library file is thus referred to as annotated. Other needed physical analysis may also be performed, and the results saved. The physical analysis only needs to be conducted once unless the related part of the design is changed. Defect density D₀ in the DDK file may be obtained from a test vehicle by the manufactures. Defect density D₀ is also related to when the integrated circuit is manufactured (referred to as manufacturing time throughout the description), and reflects the real yield on manufacturing lines for a certain period of time. For example, in FIG. 2, the line “variable2 (2005q1, 2005q2, 2005q3 . . . )” is related to periods of manufacturing time for which the time-dependent data are collected. The EDA tool thus can find the corresponding defect density D₀ for a designated period of manufacturing time.

In the preferred embodiment, the time-dependent data are saved, and offered to EDA tool vendor according to technologies, for example, 90 nm or 65 nm technologies. For each of the technologies, there is a plurality of periods of manufacturing time, for example, quarters. After a quarter, new time-dependent data may be added into the DDK. Accordingly, for each of the periods of time and for each of the technologies, one DDK file may be generated. Alternatively, all time-dependent data (including all periods of manufacturing time) for one technology may be saved in a DDK file. The format of the design library and DDK file may be determined by EDA tool venders and manufacturing foundries, and may use customized formats. Similarly, other time-dependent data, such as the data related to lithography, stress, and the like, may also be saved in the DDK files in appropriate formats.

Table 1 shows an exemplary configuration of the DDK files, wherein Tech-1 and Tech-2 are different technology generations.

TABLE 1

| Period of | | |
|---|---|---|
| Manufacturing Time | Tech-1 | Tech-2 |
| 2005q1 | yield1_05q1 | yield2_05q1 |
| 2005q3 | yield1_05q3 | yield2_05q3 |
| 2006q1 | yield1_06q1 | yield2_06q1 |

The appropriate DDK file can be found by referring to Table 1 using both the designated technology and the designated period of manufacturing time. For example, the time-dependent data for the first quarter of 2005 and technology tech-1 may be found in DDK file yield1_{—}05q1. The EDA tool may then access DDK file yield1_{—}05q1 for the corresponding yield density D₀.

A design of a buffer may be used as an example to explain the advantageous features of the embodiments of the present invention. Assuming a buffer IP is to be designed, a designer may choose to make two sets of designs, one is a high-speed design, which uses the minimum design rules, and the other is a high-yield design, which uses relaxed design rules. The design may span from the immature time of a technology to the mature time of the same technology. At the time place and route is performed, the designer may assess both the high-speed design and the high-yield design to determine the possible yields of both designs. The designer may then tradeoff between the high-speed design and the high-yield design based on whether the yield of the high-speed design is acceptable or not. If it is acceptable, the high-speed design is preferable. Otherwise, the high-yield design is preferable, even if the high-yield design takes more chip area than the high-speed design.

It can be found from the preceding paragraphs that besides the ability for assessing integrated circuit designs using the most current manufacturing process, the embodiments of the present invention provide the ability for assessing the integrated circuit designs using past manufacturing processes including previous technology generations. Accordingly, designers, if they want, can determine what the yields would be if their designs would have been manufactured using older generations of technologies, or the manufacturing process of the same technology generation, but at the previous period of manufacturing time.

It is realized that the analysis of the time-independent data is significantly more costly time-wise and resource-wise than the analysis of the time-dependent data. Therefore, a physical analysis of the time-dependent data is only performed only once when a design is created, and the result of the physical analysis is saved (for example, in the .lib file) for later access. At a later time, the assessments of the integrated circuits only need to take the saved data and combine with the time-dependent data. In an exemplary embodiment, the critical area of an IP is calculated and saved when the IP is saved, and do not need to be calculated again unless the IP is modified. Later, an assessment of a full-chip design, which uses the IP, does not need to re-calculate the critical area of the IP. Advantageously, since the costly analysis of the time-independent data is not duplicated, the re-spin cycles, which include taking the design off-line for analysis and revising the design, and overall time to market, are significantly improved.

A further advantageous feature of the present invention is that proprietary information, for example, yields, is encrypted and is only accessible to EDA tool vendors, who are presumably partners of the manufacturing foundries, and have the obligation of not revealing the proprietary information. The proprietary information is thus protected from the public and the competitors of the manufacturing foundries.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A design system comprising:
a design library comprising substantially only time-independent data;
a design-for-manufacturing (DFM) data kit comprising substantially only time-dependent data; and
a tool for reading both the time-independent data and the time-dependent data for further analysis and applications.

2. The design system of claim 1, wherein the design library comprises only the time-independent data, and wherein the DFM data kit comprises only the time-dependent data.

3. The design system of claim 1, wherein the tool is integrated into an electronic design automation (EDA) tool.

4. The design system of claim 1, wherein the DFM data kit is encrypted, and wherein the tool further comprises a decryption tool for decrypting the DFM data kit.

5. The design system of claim 1, wherein the time-independent data are selected from the group consisting essentially of physical data, electrical data, and combinations thereof.

6. The design system of claim 1, wherein the time-dependent data are selected from the group consisting essentially of lithography recipe data, yield data, and combinations thereof.

7. The design system of claim 1, wherein the DFM data kit comprises a plurality of files, each comprising the time-dependent data for a period of manufacturing time.

8. The design system of claim 1, wherein the DFM data kit comprises a plurality of files, each comprising the time-dependent data for a manufacturing technology.

9. The design system of claim 1, wherein the DFM data kit is external to the design library.

10. The design system of claim 1, wherein the time-dependent data comprises past data or forecast data of a period of manufacturing time.

11. A design system comprising:
a design library comprising substantially only time-independent data for designing and manufacturing an integrated circuit;
a design-for-manufacturing (DFM) data kit comprising substantially only time-dependent data for designing and manufacturing the integrated circuit;
an encryption tool for encrypting the time-dependent data;
a decryption tool for decrypting the time-dependent data; and
an electronic design automation (EDA) tool for reading the time-independent data, and reading the time-dependent data using the decryption tool.

12. The design system of claim 11, wherein the DFM data kit comprises a plurality of sets of data, each comprising time-independent data for a period of manufacturing time.

13. The design system of claim 12, wherein the EDA tool has a function for assessing a yield for manufacturing an integrated circuit using manufacturing processes of two different past periods of time.

14. The design system of claim 11, wherein the DFM data kit comprises a plurality of sets of data, each comprising time-independent data for a technology.

15. The design system of claim 14, wherein the EDA tool has a function for assessing yields of manufacturing an integrated circuit using two different technologies.

16. The design system of claim 11, wherein the time-independent data comprise a critical area of an integrated circuit, the time-dependent data comprise a defect density, and wherein the EDA tool has a function for calculating a yield using the critical area and the defect density.

17. The design system of claim 11, wherein the time-independent data are selected from the group consisting essentially of physical data, electrical data, and combinations thereof.

18. The design system of claim 11, wherein the time-dependent data are selected from the group consisting essentially of lithography recipe data, yield data, and combinations thereof.

19. A design system comprising:
a design library comprising substantially only time-independent data for designing and manufacturing an integrated circuit, wherein the time-independent data comprise a critical area of the integrated circuit;
a design-for-manufacturing (DFM) data kit comprising substantially only time-dependent data for designing and manufacturing the integrated circuit, wherein the time-dependent data comprise a defect density;
an encryption tool for encrypting the time-dependent data in the DFM data kit;
a decryption tool for decrypting the time-dependent data; and
an electronic design automation (EDA) tool for reading the critical area, reading the defect density using the decryption tool, and for calculating a yield using the critical area and the defect density.

20. The design system of claim 19, wherein the DFM data kit comprises a plurality of files, each comprising defect densities collected from a period of manufacturing time.

21. The design system of claim 19, wherein the EDA tool is configured to calculate yields of different periods of manufacturing time.

22. The design system of claim 19, wherein the EDA tool is configured to calculate yields of different technologies.

23. A method for designing and manufacturing integrated circuits, the method comprising:
providing a modeling parameter set for manufacturing an integrated circuit;
dividing the modeling parameter set into time-dependent data and time-independent data;
saving substantially all time-independent data into a design library; and
saving substantially all time-dependent data into a design-for-manufacturing (DFM) data kit, wherein the DFM data kit is external to the design library.

24. The method of claim 23 further comprising providing a tool for accessing the time-dependent data and the time-independent data.

25. The method of claim 23 further comprising encrypting the time-dependent data in the DFM data kit.

26. The method of claim 25 further comprising decrypting the time-dependent data and saving the encrypted time-dependent data in the DFM data kit.

27. The method of claim 25 further comprising performing a physical analysis when the time-independent data is saved in the design library, and saving results of the physical analysis.

28. The method of claim 25, wherein the time-dependent data comprise past data of a past period of manufacturing time, and wherein the method further comprises performing an assessment for the past period of manufacturing time using the past data.

29. The method of claim 25, wherein the time-dependent data comprise a first set of data for a first technology, and a second set of data for a second technology, and wherein the method further comprises performing an assessment for both the first and the second technologies.

30. The method of claim 23 further comprising periodically adding new time-independent data into the DFM data kit.

31. The method of claim 23, wherein the time-independent data comprise a critical area, the time-dependent data comprise a defect density, and wherein the method further comprises retrieving the critical area and the defect density, and calculating a yield using the critical area and the defect density.

32. A method for designing and manufacturing integrated circuits, the method comprising:
providing a modeling parameter set for manufacturing an integrated circuit;
dividing the modeling parameter set into time-dependent data and time-independent data;
saving substantially all time-independent data into a design library;
at the time the time-independent data is saved, calculating a critical area of the integrated circuit and saving the critical area; and
saving substantially all time-dependent data into a design-for-manufacturing (DFM) data kit external to the design library, wherein the time-dependent data comprise a defect density.

33. The method of claim 32 further comprising calculating a yield using the critical area and the defect density.

34. The method of claim 32 further comprising encrypting and decrypting the time-dependent data.

35. The method of claim 32, wherein the time-dependent data comprise a past defect density of a past period of manufacturing time, and wherein the method further comprises calculating a yield using the past yield and the critical area.

36. The method of claim 32, wherein the time-dependent data comprise a first defect density of a first technology, and a second defect density of a second technology, and wherein the method further comprises calculating yields for both the first and the second technologies.
